(19) United States
(12) Patent Application Publication
(10) Pub. No.: US 2026/0111838 A1
(43) Pub. Date: Apr. 23, 2026

(54) METHOD AND SYSTEM ARRANGEMENT FOR OPTIMIZING PRODUCTION PLANNINGS OF PRODUCTS AND GOODS OR SHOP FLOOR LOGISTICS IN PRODUCING, TRADING OR DISTRIBUTING PRODUCTS AND GOODS

(71) Applicant: Siemens Aktiengesellschaft, München (DE)

(72) Inventors: Kai Wurm, München (DE); André Scholz, Deining (DE); Pascal Ziegler, Schwarzenbruck (DE); Stephan Fischer, Chemnitz, Sachsen (DE); Georg von Wichert, München (DE); Dragan Obradovic, Ottobrunn (DE); Dieter Cramer, München, Bayern (DE)

(21) Appl. No.: 19/153,157

(22) PCT Filed: Feb. 2, 2024
(86) PCT No.: PCT/EP2024/052588

§ 371 Date: Aug. 1, 2025

(30) Foreign Application Priority Data
Feb. 7, 2023 (EP) 23155369.4

(51) Int. Cl. G06Q 10/087; G05D 1/698; G05D 105/20; G05D 107/70; G05D 109/10; G05D 111/30; G05D 111/67; G06N 7/01; G06Q 10/04; G06Q 10/0631

(52) U.S. Cl. CPC G06Q 10/08726; G05D 1/6987; G06N 7/01; G06Q 10/04; G06Q 10/06316; G05D 2105/20; G05D 2107/70; G05D 2109/10; G05D 2111/30; G05D 2111/67

(57) ABSTRACT

A production plannings of products and goods or shop floor logistics in producing, trading or distributing products/goods is provided in which it is addressed to maintain or keep data about the production planning of the products and goods or the shop floor regarding the logistics in producing, trading or distributing the products and goods up to date, and at least one mobile logistics robot to automate a logistic transport of the products, the goods or production material for the products and goods within a shop floor is equipped each with a sensor technology appropriate to measure or capture and control a current state or changes of the shop floor by sensor data, when each the robot is managed by a fleet management system for distributing or scheduling logistic tasks among the at least one robot executing transport tasks of a transport task queue maintained by an automated logistics planning system.

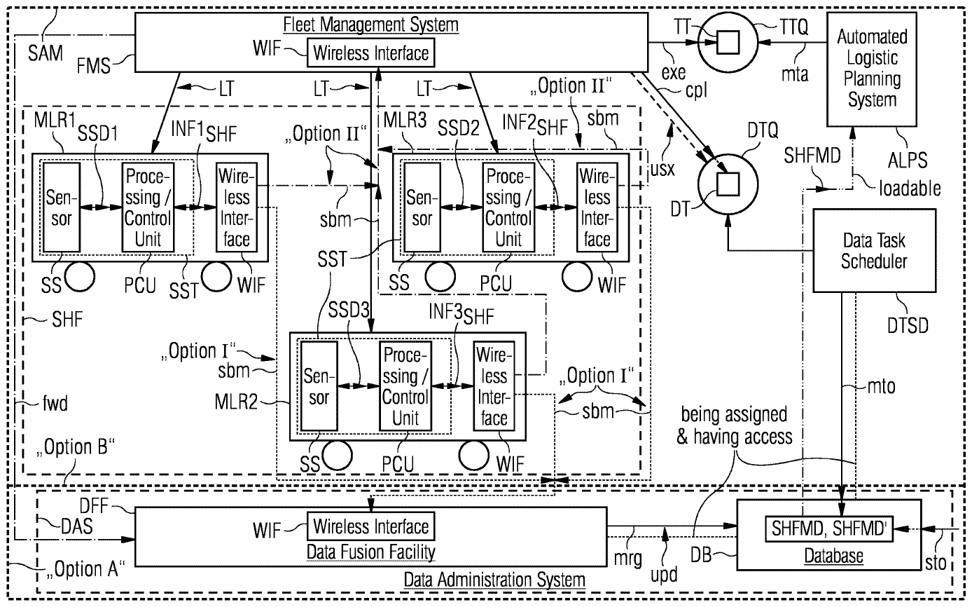

### CROSS-REFERENCE TO RELATED APPLICATIONS

This application is a national stage of PCT Application No. PCT/EP2024/052588, having a filing date of Feb. 2, 2024, which claims priority to EP Application No. 23155369.4, having a filing date of Feb. 7, 2023, the entire contents both of which are hereby incorporated by reference.

### FIELD OF TECHNOLOGY

The following relates to a method for optimizing production plannings of products and goods or shop floor logistics in producing, trading or distributing products and goods, a system arrangement for optimizing production plannings of products and goods or shop floor logistics in producing, trading or distributing products and goods.

### BACKGROUND

In order to optimize either production plannings of products and goods or shop floor logistics in producing, trading or distributing products and goods it is necessary to have knowledge about the shop floors, in particular the use of production equipment, the locations of assets, the utilization of buffer areas and the information about the distribution of mobile equipment and human workers in the shop floors. Keeping track of this knowledge information is rarely automated and, especially in low-volume high-mix production, this information can change rapidly with new production tasks.

There are existing technical solutions to automatically track locations of assets in shop floors. These solutions are realized systems being usually called as “Real-Time-Locating-Systems <RTLS>”. Regarding these RTL-Systems there are existing several technical implementations, e.g., using Bluetooth or ultra-wideband beacons and receivers. In these systems beacons are attached to the assets and material to be tracked. The RTL-System allows to have up-to-date information of shop floor data but comes at the price of installing significant infrastructure, e.g., the receivers and beacons.

Alternatively, if no RTL-System is used, information about a production shop floor is kept up to date by predicting a state of the shop floor from a previous known state and manually checking an actual state to correct the prediction.

US2022/300875A1 discloses a system having at least one plant system having at least a plurality of agents, having at least a plurality of autonomous mobile robots, movable machinery, and a plurality of sensors for generating data for use for the safety relevant securing of the plant system, wherein a local plant safety system associated with the plant system is present, wherein data of the local plant safety system are stored in a first database, wherein the local plant safety system has a first data model having datasets of the plant system, wherein a decentral public plant library system associated with the local plant safety system is present, wherein the plant safety system and the plant library system are connected to one another via an interface, and. wherein data and datasets can be transmitted between the plant safety system and the plant library system via the interface.

CN111198530A discloses a method for clouding the robot in the 5G environment comprises a plurality of intelligent manufacturing cloud centers, wherein an intelligent manufacturing mechanism model of the robot is arranged at the cloud end, the intelligent manufacturing mechanism model is issued to the robot, and the robot performs intelligent cooperation according to the intelligent manufacturing mechanism model.

### SUMMARY

An aspect relates to a method and system arrangement for optimizing production plannings of products and goods or shop floor logistics in producing, trading or distributing products and goods, in which it is addressed to maintain or keep data about (i) the production planning of the products and goods or (ii) the shop floor regarding the logistics in producing, trading or distributing the products and goods up to date.

This aspect involves gathering information about (i) the production planning of the products and goods or (ii) the shop floor logistics producing, trading or distributing the products and goods inter alia regarding equipment being used, locations of assets such as tools or robots or automated machines, utilization of buffer areas as well as information about the distribution of mobile equipment and human workers regarding the production planning or in the shop floor.

The main idea of embodiments of the invention in order to optimize production plannings of products and goods or shop floor logistics in producing, trading or distributing products and goods, in which at least one mobile logistics robot to automate a logistic transport of the products, the goods or production material for the products and goods within a shop floor is equipped each with a sensor technology including at least one sensor and a processing/control unit appropriate to measure or capture and control a current state or changes of the shop floor by sensor data, when each the robot is managed by a fleet management system for distributing or scheduling logistic tasks among the at least one mobile logistics robot executing transport tasks of a transport task queue maintained by an automated logistics planning system for planning the logistic transport to which the mobile logistics robot and the fleet management system are assigned, it is proposed as key aspects of the idea to:
(1) store in a database of a data administration system shop floor master data of the shop floor, which are used to plan the shop floor logistics and loadable into the automated logistics planning system;
(2) extract from the sensor data-based measurements or captures shop floor related information by the processing/control unit;
(3) submit the shop floor related information by each of the at least one mobile logistics robot to a data fusion facility of the data administration system for gathering the shop floor related information; and
(4) update the stored shop floor master data through the data fusion facility having access to the database by merging the stored shop floor master data with the gathered shop floor related information in a corresponding manner.

The at least one mobile logistics robot is an “Automated Guided Vehicle <AGV>” or an autonomous forklift. But of course, it is generally possible that the mobile logistics robot could be any other mobile automated machine.

Moreover, the sensor is a 2D- and/or 3D-camera, a 2D- and/or 3D-“Light Detection and Ranging <LIDAR>-sensor”, a time-of-flight sensor, a stereo camera, a “Radio-Frequency IDentification <RFID>”-detector, a microphone for capturing noises from persons, engines and/or machine tools or any other volumetric sensor. But of course it is also generally possible that the sensor could be any other device with a different detecting technology.

The proposed solution differs from the state of the art using a dedicated RTLS-technology and described in the beginning by generating additional benefits with an existing mobile logistics robot fleet,
no needs to install additional sensors on the robots because most of the used mobile logistics robots are already be equipped with appropriate sensors for their primary function of navigating the shop floor;
enabling savings in manual efforts when the manual update of the master data of the shop floor and the shop floor related information is replaced by the automated solution as presented according to embodiments of the invention when the stored shop floor master data is getting updated by merging the stored shop floor master data with the gathered shop floor related information extracted from the sensor data-based measurements or captures; and
achieving a better data quality when the database storing the master data will be updated continuously updated, e.g., the database is more accurate and less old, than the database is only updated when it is needed.

According to an advantageous development of the presented idea the shop floor related information extracted from the robot measurements is at least one of (i) data about utilization a space of the shop floor, (ii) data about persons that are present in different areas of the shop floor and (iii) data about a location of assets of the shop floor.

Regarding (i) the data concern for example buffer zones, material delivery or storage, material input and output of production machines such as machine tools and shipping areas as well as noises from engines and machine tools. The utilization of such areas can be estimated using the 3D-camera, the 3D-“Light Detection and Ranging <LIDAR>-sensor”, the time-of-flight sensor, the stereo camera, or the volumetric sensor respectively the microphone for capturing the noises.

Regarding (ii) the presence of the data in the different areas of the shop floor are given by areas around production machines, commissioning stations, inbound or outbound logistics areas, or packaging stations, while the number of persons in these area can be estimated by using the 2D-camera, the 3D-sensor, the 2D/3D-“Light Detection and Ranging <LIDAR>-sensor” or the microphone.

Regarding (iii) the location of the assets can be identified with the 2D-camera either using object recognition algorithms or machine-readable codes such as QR codes, the 3D-camera using object recognition algorithms, or the RFID-detectors for assets that are tagged with RFID-markers or the microphone for capturing noises from the engines and the machine tools.

According to a further beneficial development of the presented idea the shop floor related information shop floor related information are submitted to the data fusion facility continuously either (“Option I”) via a wireless connection from the at least one mobile logistics robot to the data fusion facility including each a wireless interface or (“Option II”) via a wireless connection from the at least one mobile logistics robot to the fleet management system including each a wireless interface, wherein for forwarding the shop floor related information the fleet management system is connected with the data fusion facility.

Furthermore, it is of a particular advantage, when in a case where the gathered shop floor related information submitted from at least two mobile logistics robots concerns indeed a same state of the shop floor but the gathered shop floor related information from the at least two mobile logistics robots is different, because the at least two mobile logistics robots are at different locations in the shop floor, then the data fusion facility derives the most likely state of the shop floor by using probabilistic state estimation techniques such as a “Bayesian filter”.

In addition it is beneficial to monitor the shop floor master data by a data task scheduler assigned and having access to the database to identify a specific stored shop floor master data of the stored shop floor master data that requires an update, for example if the identified specific data has not been updated for a given time period, and to maintain a data task queue through the data task scheduler, wherein the data task queue is used by the fleet management system in a way where either the executed transport tasks of the transport task queue are prioritized with regard to whether the executed transport task also completes a data task of the data task queue or if the at least one mobile logistics robot is not occupied with one logistic task distributed or scheduled by the fleet management system the mobile logistics robot is scheduled instead only with a data task of the data task queue.

Besides the above, developments of embodiments of the invention arise out of the following description of an embodiment of the invention according to a lonely FIGURE showing a system arrangement for optimizing production plannings of products and goods or shop floor logistics in producing, trading or distributing products and goods.

### BRIEF DESCRIPTION

Some of the embodiments will be described in detail, with reference to the following figures, wherein like designations denote like members, wherein:

The FIGURE depicts a system arrangement SAM for optimizing production plannings of products and goods or shop floor logistics in producing, trading or distributing products and goods, wherein embodiments of the system arrangement SAM include besides an automated logistics planning system ALPS in addition a fleet management system FMS and at least one mobile logistics robot MLR1, MLR2, MLR3. Both, the fleet management system FMS and the at least one mobile logistics robot MLR1, MLR2, MLR3 are assigned to the automated logistics planning system ALPS. According to the depicted system arrangement SAM there are for example three mobile logistics robots, a first mobile logistics robot MLR1, a second mobile logistics robot MLR2 and a third mobile logistics robot MLR3, which can be operated regarding logistic transports in a shop floor SHF of embodiments of the system arrangement SAM.

### DETAILED DESCRIPTION

The mobile logistics robots MLR1, MLR2, MLR3 are “Automated Guided Vehicle's <AGV>” or autonomous forklifts.

In order to automate a logistic transport of the products, the goods or production material for the products and goods within the shop floor SHF (1) the three mobile logistics robots MLR1, MLR2, MLR3 are equipped each with a sensor technology SST and (2) three mobile logistics robots MLR1, MLR2, MLR3 are managed by the fleet management system FMS for distributing or scheduling logistic tasks LT among the three mobile logistics robots MLR1, MLR2, MLR3 for executing exe transport tasks TT of a transport task queue TTQ maintained mta by the automated logistics planning system ALPS to plan the logistic transport.

The cited sensor technology SST each of the mobile logistics robots MLR1, MLR2, MLR3 is equipped with includes each at least one sensor SS and a processing/control unit PCU. Each sensor SS of the mobile logistics robots MLR1, MLR2, MLR3 is appropriate to measure or capture a current state or changes of the shop floor SHF by generating sensor data SSD1, SSD2, SSD3. So, the first mobile logistics robot MLR1 generates first sensor data SSD1, the second mobile logistics robot MLR2 generates second sensor data SSD2 and the third mobile logistics robot MLR3 generates third sensor data SSD3.

The used sensor SS of the sensor technology SST can be a 2D- and/or 3D-camera, a 2D- and/or 3D-“Light Detection and Ranging <LIDAR>-sensor”, a time-of-flight sensor, a stereo camera, a “Radio-Frequency IDentification <RFID>”-detector, a microphone for capturing noises from engines and machine tools or any other volumetric sensor.

After that for processing the sensor data and controlling the current state or changes of the shop floor SHF each processing/control unit PCU of the mobile logistics robots MLR1, MLR2, MLR3 extracts ext from the sensor data-based measurements or captures shop floor related information INF1_{SHF}, INF2_{SHF}, INF3_{SHF}. So, the first mobile logistics robot MLR1 extracts from the first sensor data SSD1 first shop floor related information INF1_{SHF}, the second mobile logistics robot MLR2 extracts from the second sensor data SSD2 second shop floor related information INF2_{SHF} and the third mobile logistics robot MLR3 extracts from the third sensor data SSD3 third shop floor related information INF3_{SHF}.

In embodiments, the system arrangement SAM further includes according to an “Option A” a data administration system DAS or alternatively according to an “Option B” a data administration system DAS is assigned to embodiments of the system arrangement SAM. In both cases the data administration system DAS includes a database DB, which stores sto shop floor master data SHFMD of the shop floor SHF. The shop floor master data SHFMD are used to plan the production of the products and goods or the shop floor logistics and thus can be loaded into the automated logistics planning system ALPS.

The data administration system DAS includes further a data fusion facility DFF, which is assigned and has access to the database DB and to which the shop floor related information INF1_{SHF}, INF2_{SHF}, INF3_{SHF} are submitted sbm by the mobile logistics robots MLR1, MLR2, MLR3 for gathering the shop floor related information INF1_{SHF}, INF2_{SHF}, INF3_{SHF}.

The shop floor related information INF1_{SHF}, INF2_{SHF}, INF3_{SHF}, which is extracted ext from the robot measurements is at least one of data about utilization a space of the shop floor SHF, data about persons that are present in different areas of the shop floor SHF and data about a location of assets of the shop floor SHF.

For the submission of the shop floor related information INF1_{SHF}, INF2_{SHF}, INF3_{SHF} the mobile logistics robots MLR1, MLR2, MLR3 include each a wireless interface WIF. By this wireless interfaces WIF the shop floor related information INF1_{SHF}, INF2_{SHF}, INF3_{SHF} are submitted sbm to the data fusion facility DFF, which includes also for this purpose each a wireless interface WIF. The submission is done continuously.

Moreover the shop floor related information INF1_{SHF}, INF2_{SHF}, INF3_{SHF} can be submitted either according to an “Option I” via wireless connections from the mobile logistics robots MLR1, MLR2, MLR3 to the data fusion facility DFF or according to an “Option II” via wireless connections from the mobile logistics robots MLR1, MLR2, MLR3 to the fleet management system FMS, which is connected with the data fusion facility DFF for forwarding fwd the shop floor related information INF1_{SHF}, INF2_{SHF}, INF3_{SHF}.

The data fusion facility DFF to which the shop floor related information INF1_{SHF}, INF2_{SHF}, INF3_{SHF} are submitted sbm by the mobile logistics robots MLR1, MLR2, MLR3 has access to the database DB and updates upd the stored shop floor master data SHFMD by merging mrg the stored shop floor master data SHFMD with the gathered shop floor related information INF1_{SHF}, INF2_{SHF}, INF3_{SHF} in a corresponding manner. Merging in a corresponding manner means that the gathered shop floor related information INF1_{SHF}, INF2_{SHF}, INF3_{SHF} is not merged arbitrarily but rather purposeful where the gathered shop floor related information INF1_{SHF}, INF2_{SHF}, INF3_{SHF} correspond to data of the stored shop floor master data SHFMD.

The data fusion facility DFF is furthermore designed in an advantageous manner such that the facility derives—in a case where the gathered shop floor related information INF1_{SHF}, INF2_{SHF}, INF3_{SHF} submitted from two mobile logistics robots, for example the first mobile logistics robot MLR1 and the second mobile logistics robot MLR2 or the second mobile logistics robot MLR2 and the third mobile logistics robot MLR3 or the first mobile logistics robot MLR1 and the third mobile logistics robot MLR3, concerns indeed a same state of the shop floor SHF but the gathered shop floor related information from the two mobile logistics robots is different, because the two mobile logistics robots are at different locations in the shop floor SHF—the most likely state of the shop floor SHF by using probabilistic state estimation techniques such as a “Bayesian filter”.

Finally, in embodiments, the system arrangement SAM includes a data task scheduler DTSD, which is assigned and has access to the database DB of the data administration system DAS. By having this access the data task scheduler DTSD (i) monitors mto the shop floor master data SHFD in the database DB to identify a specific stored shop floor master data SHFMD′ of the stored shop floor master data SHFMD that requires an update, for example if the identified specific data SHFMD′ has not been updated for a given time period, and (ii) maintains mtg a data task queue DTQ.

This data task queue DTQ can be used usx by the fleet management system FMS in a way where either the executed transport tasks TT of the transport task queue TTQ are prioritized with regard to whether the executed transport task TT also completes cpl a data task DT of the data task queue DTQ or if at least one of the mobile logistics robots MLR1, MLR2, MLR3 is not occupied with one logistic task LT distributed or scheduled by the fleet management system FMS this at least one mobile logistics robot MLR1, MLR2, MLR3 is scheduled instead only with a data task DT of the data task queue DTQ.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for optimizing production plannings of products and goods or shop floor logistics in producing, trading or distributing products and goods, wherein at least one mobile logistics robot to automate a logistic transport of the products, the goods or production material for the products and goods within a shop floor is equipped each with a sensor technology including at least one sensor and a processing/control unit appropriate to measure or capture and control a current state or changes of the shop floor by sensor data, when each the robot is managed by a fleet management system for distributing or scheduling logistic tasks among the at least one mobile logistics robot executing transport tasks of a transport task queue maintained by an automated logistics planning system for planning the logistic transport to which the mobile logistics robot and the fleet management system are assigned,
wherein:
a) storing in a database of a data administration system shop floor master data of the shop floor, which are used to plan the production of the products and goods or the shop floor logistics and loadable into the automated logistics planning system;
b) extracting from the sensor data-based measurements or capturing shop floor related information by the processing/control unit;
c) submitting the shop floor related information by each of the at least one mobile logistics robot to a data fusion facility of the data administration system for gathering the shop floor related information; and
d) updating the stored shop floor master data through the data fusion facility having access to the database by merging the stored shop floor master data with the gathered shop floor related information in a corresponding manner,
wherein in a case where the gathered shop floor related information submitted from at least two mobile logistics robots concerns indeed a same state of the shop floor but the gathered shop floor related information from the at least two mobile logistics robots is different, the data fusion facility derives the most likely state of the shop floor by using probabilistic state estimation techniques such as a “Bayesian filter”.

2. The method according to claim 1, wherein: the shop floor related information extracted from the robot measurements is at least one of data about utilization a space of the shop floor, data about persons that are present in different areas of the shop floor and data about a location of assets of the shop.

3. The method according to claim 1, wherein: the shop floor related information are submitted to the data fusion facility, continuously, either via a wireless connection from the at least one mobile logistics robot to the data fusion facility including each a wireless interface or via a wireless connection from the at least one mobile logistics robot to the fleet management system including each a wireless interface, wherein for forwarding the shop floor related information the fleet management system is connected with the data fusion facility.

4. The method according to claim 1, wherein:
monitoring the shop floor master data through a data task scheduler assigned and having access to the database to identify a specific stored shop floor master data of the stored shop floor master data that requires an update, if the identified specific data has not been updated for a given time period; and
maintaining a data task queue through the data task scheduler.

5. The method according to claim 4, wherein: the data task queue is used by the fleet management system such that
the executed transport tasks of the transport task queue are prioritized with regard to whether the executed transport task also completes a data task of the data task queue; or
if the at least one mobile logistics robot is not occupied with one logistic task distributed or scheduled by the fleet management system the mobile logistics robot is scheduled instead only with a data task of the data task queue.

6. The method according to claim 1, wherein:
the at least one mobile logistics robot is an “Automated Guided Vehicle <AGV>” or an autonomous forklift.

7. The method according to claim 1, wherein:
the sensor is a 2D- and/or 3D-camera, a 2D- and/or 3D-“Light Detection and Ranging <LIDAR>-sensor”, a time-of-flight sensor, a stereo camera, a “Radio-Frequency IDentification <RFID>”-detector, a microphone for capturing noises from persons, engines and/or machine tools or any other volumetric sensor.

8. A system arrangement for optimizing production plannings of products and goods or shop floor logistics in producing, trading or distributing products and goods, with an automated logistics planning system as well as a fleet management system and at least one mobile logistics robot, which are both assigned to the automated logistics planning system, wherein to automate a logistic transport of the products, the goods or production material for the products and goods within a shop floor the at least one mobile logistics robot is equipped with a sensor technology including at least one sensor and a processing/control unit appropriate to measure or capture and control a current state or changes of the shop floor by sensor data, when each the robot is managed by the fleet management system for distributing or scheduling logistic tasks among the at least one mobile logistics robot executing transport tasks of a transport task queue maintained by the automated logistics planning system to plan the logistic transport,
wherein:
a) a database of a data administration system, which is included in or assigned to the system arrangement, storing shop floor master data of the shop floor, which are used to plan the production of the products and goods or the shop floor logistics and loadable into the automated logistics planning system;
b) the processing/control unit of each the at least one mobile logistics robot extracting from the sensor data-based measurements or capturing shop floor related;
c) a data fusion facility of the data administration system to which the shop floor related information are submitted by each of the at least one mobile logistics robot for gathering the shop floor related information; and
d) the data fusion facility having access to the database updating the stored shop floor master data by merging the stored shop floor master data with the gathered shop floor related information in a corresponding manner,
wherein the data fusion facility derives in a case where the gathered shop floor related information submitted from at least two mobile logistics robots concerns indeed a same state of the shop floor but the gathered shop floor related information from the at least two mobile logistics robots is different, the most likely state of the shop floor by using probabilistic state estimation techniques such as a “Bayesian filter”.

9. The system arrangement according to claim 8, wherein:
the shop floor related information extracted from the robot measurements is at least one of data about utilization a space of the shop floor, data about persons that are present in different areas of the shop floor and data about a location of assets of the shop.

10. The system arrangement according to claim 8, wherein:
a wireless interface of the mobile logistics robot, the fleet management system and the data fusion facility, wherein the shop floor related information are submitted to the data fusion facility, continuously, either via a wireless connection from the mobile logistics robot to the data fusion facility or via a wireless connection from the mobile logistics robot to the fleet management system, which is connected with the data fusion facility for forwarding the shop floor related information.

11. The system arrangement according to claim 8, wherein:
a data task scheduler assigned and having access to the database
monitoring the shop floor master data to identify a specific stored shop floor master data of the stored shop floor master data that requires an update, if the identified specific data has not been updated for a given time period; and
maintaining a data task queue.

12. The system arrangement according to claim 11, wherein:
the fleet management system uses the data task queue such that
the executed transport tasks of the transport task queue are prioritized with regard to whether the executed transport task also completes a data task of the data task queue; or
if the at least one mobile logistics robot is not occupied with one logistic task distributed or scheduled by the fleet management system the at least one mobile logistics robot is scheduled instead only with a data task of the data task queue.

13. The system arrangement according to claim 8, wherein:
the at least one mobile logistics robot is an “Automated Guided Vehicle <AGV>” or an autonomous forklift.

14. The system arrangement according to claim 8, wherein:
the sensor is a 2D- and/or 3D-camera, a 2D- and/or 3D-“Light Detection and Ranging <LIDAR>-sensor”, a time-of-flight sensor, a stereo camera, a “Radio-Frequency IDentification <RFID>”-detector, a microphone for capturing noises from persons, engines and/or machine tools or any other volumetric sensor.
